(19) United States
(12) Patent Application Publication
(10) Pub. No.: US 2006/0153298 A1
(43) Pub. Date: Jul. 13, 2006

(54) Predictive encoding of motion vectors including a flag notifying the presence of coded residual motion vector data

(75) Inventor: Stephane Valente, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINNKJKLE PHILLIPS ELECTRONICS N.V.

(21) Appl. No.: 10/543,951

(22) PCT Filed: Jan. 30, 2004
(86) PCT No.: PCT/IB04/00266

§ 371 Date: Aug. 1, 2005

(30) Foreign Application Priority Data
Feb. 4, 2003 (EP) 03290282.7

(51) Int. Cl. H04N 11/02; H04N 7/12; H04N 11/04; H04B 1/66

(52) U.S. Cl. 375/240.16; 375/240.25

(57) ABSTRACT

The invention relates to a video encoding method applied to a sequence of video frames and generating a coded bitstream in which each data item is described by means of a bitstream syntax allowing any decoder to recognize and decode all the segments of the content of said bitstream. This method includes a predicting step, based on a prediction technique using a motion compensation operation, and a subtracting step, based on a subtraction of said predicted frame from the current one, and the motion compensation operation leads to motion vectors with horizontal and vertical components (MVx, MVy). These components have to be encoded differentially by using predictions (Px, Py) of said components and, in fact, only the differences (dx, dy) between the components and their predictions (Px, Py) are therefore encoded. According to the invention, said syntax includes an additional flag indicating that said differences (dx, dy) are present, or not, in the generated coded bitstream, and will have therefore to be decoded, or not, at the decoding side.

### FIELD OF THE INVENTION

The present invention generally relates to the field of video compression and, for instance, more particularly to the video standards of the MPEG family (MPEG-1, MPEG-2, MPEG-4) and to the video coding recommendations of the ITU H26X family (H.261, H.263 and extensions). More specifically, the invention relates to a video encoding method applied to a sequence of video frames and generating a coded bitstream in which each data item is described by means of a bitstream syntax allowing any decoder to recognize and decode all the segments of the content of said bitstream, said method including a predicting step, based on a prediction technique using a motion compensation operation between a previous frame and the current one and provided for generating a predicted frame, and a subtracting step, based on a subtraction of said predicted frame from the current one and provided for generating the signal to be encoded, said motion compensation operation itself leading to the generation of motion vectors the horizontal and vertical components (MVx, MVy) of which have to be encoded differentially by using predictions (Px, Py) of said components and encoding only the differences (dx, dy) between said motion vector components and said predictions (Px, Py).

The invention also relates to an encoding device for carrying out said encoding method, to a transmittable video signal consisting of a coded bitstream generated by such an encoding device, and to a corresponding decoding method and device.

### BACKGROUND OF THE INVENTION

In the current video standards (up to the video coding MPEG-4 standard and the H.264 recommendation), the video, described in terms of one luminance channel and two chrominance ones, can be compressed thanks to two coding modes applied to each channel: the “intra” mode, exploiting in a given channel the spatial redundancy of the picture elements (pixels) within each image (or frame, or picture), and the “inter” mode, exploiting the temporal redundancy between separate images (or frames, or pictures). The inter mode, relying on a motion compensation operation, allows to describe an image from one (or more) previously decoded image(s) by encoding the motion of the pixels from one image to another one.

Usually, the current picture to be coded is partitioned into independent blocks, and each of them is assigned a motion vector. A motion estimation, provided for finding the most similar blocks between pictures—a previous picture, used as a reference, one and the current one—allows to determine these motion vectors, corresponding for each block to the displacement which represents the degree of motion between these most similar blocks in said references and current pictures. A prediction of said image can then be constructed by displacing the pixel blocks from the reference image according to the set of motion vectors associated to the blocks. Finally, the difference between the current image to be encoded and its motion-compensated prediction (called the residual signal) can be encoded in the intra mode. All three channels share such a motion description.

The invention relates more specifically to the encoding of the motion vectors. In the MPEG-4 standard, and as described for instance in the UK patent application GB 2329295, these motion vectors have for each block horizontal and vertical components, MVx and MVy respectively, and these motion vector components are encoded differentially: in fact, a prediction (Px and Py respectively) is used, and only the differences dx and dy (also called residues) between each motion vector component (MVx, MVy) and its prediction (Px, Py) are encoded. These predictions are formed, as illustrated by the different examples shown in FIG. 1 for a 8×8 pixels mode macroblock, by a median filtering of three vector candidate predictors (MV1, MV2, MV3) from the spatial neighbourhood macroblocks or blocks already decoded:
Px=Median (MV1x, MV2x, MV3x) (1)
Py=Median (MV1y, MV2y, MV3y) (2)
where MV1x, MV2x, MV3x designate the horizontal components of the predictors and MV1y, MV2y, MV3y their vertical components. Each motion vector (MVx, MVy) to be encoded is described as the sum of the prediction (Px, Py) and the components (dx, dy), but, as said above, only the unpredictable difference components (dx, dy) are actually encoded in the video bitstream for each motion-compensated block: in fact, a compression gain is thus obtained because (dx, dy) have better statistical properties than (MVx, MVy).

It may be noted that this method is not limited to MPEG-4 and that a similar motion vector coding method is found in the video coding recommendation H.264, still relying on the encoding of motion vector residues added to the motion vector predictions made from spatial and temporal neighbouring motion vectors. One of the drawbacks that can be however identified with such encoding schemes is that a motion vector residue always needs to be encoded to satisfy the bitstream syntax, even if it is zero (i.e. if the encoded/decoded motion vector is the predicted one).

### SUMMARY OF THE INVENTION

It is therefore a first object of the invention to propose a video coding method in which this drawback is avoided.

To this end, the invention relates to a coding method such as defined in the introductory part of the description and which is moreover characterized in that said syntax includes an additional flag indicating that said differences (dx, dy) are present, or not, in said generated coded bitstream. It also relates to a corresponding video encoding device, and to a transmittable video signal consisting of a bitstream coded by means of such an encoding device.

Due to this additional syntactic element incorporated into the coded bitstream, the decoder that will receive a coded bitstream including this element will be able to take into account its value and thus to know if the residue (dx, dy) is present in said coded bitstream to be decoded.

It is another object of the invention to propose a video decoding method for decoding said transmittable video signal and a corresponding video decoding device.

### BRIEF DESCRIPTION OF THE DRAWINGS

The invention will now be described in a more detailed manner, with reference to the accompanying drawings in which:

FIG. 1 illustrates four cases of definition of the candidate predictors (MV1, MV2, MV3) for each of the luminance blocks in a macroblock;

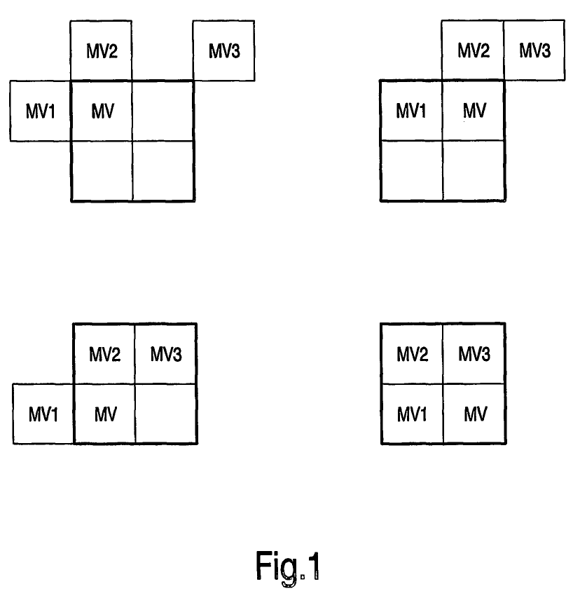

FIG. 2 shows an example of an MPEG encoder with motion compensated interframe prediction.

### DETAILED DESCRIPTION OF THE INVENTION

The proposed solution consists in defining in the syntax of the video concerned standard or recommendation an additional element, which is a syntax flag, called for instance MV_RESIDUE and which can take the values 0 or 1. The encoder may thus decide whether it needs to encode the residue (dx, dy) or not—by setting MV_RESIDUE to one of two values, 1 for example, in the bitstream or, on the contrary, by setting MV_RESIDUE to the other value, 0 for example. Due to this additional syntactic element indicating the presence, or not, of a residue, at the decoding side the decoder can determine which motion vector was encoded by using the predicted motion vector, and adding the residue (dx, dy) if it is present in the bitstream.

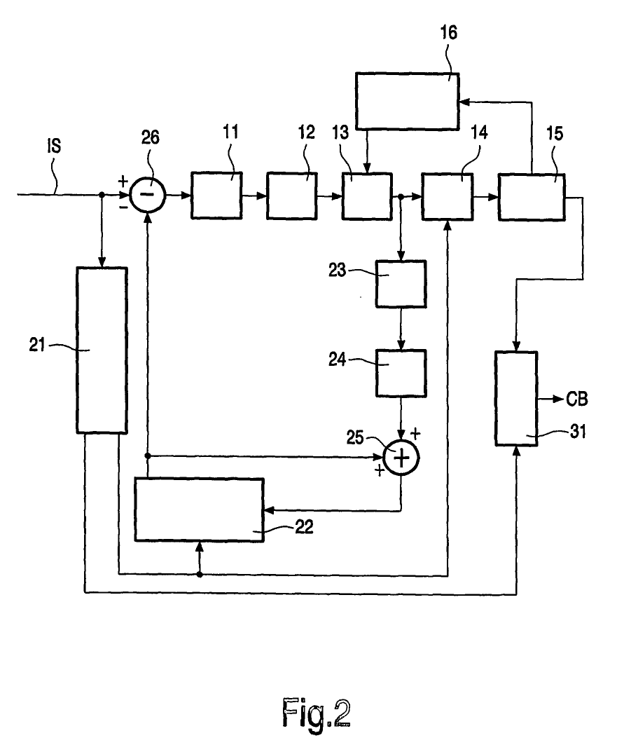

The video coding method described above may be for instance implemented in an encoding device such as for instance the one illustrated in FIG. 2 showing an example of an MPEG encoder with motion compensated interframe prediction. This encoder comprises coding and prediction stages. The coding stage itself comprises in series a mode decision circuit 11 (for determining the selection of a coding mode I, P or B as defined in MPEG), a DCT circuit 12, a quantization circuit 13, a variable-length coding circuit 14, a buffer 15, and a rate control circuit 16 allowing to control the quantization step size of the quantization circuit 13. The prediction stage comprises a motion estimation circuit 21 followed by a motion compensation circuit 22, and also, in series between the output of the quantization circuit 13 and the input of the motion compensation circuit 22, an inverse quantization circuit 23, an inverse DCT circuit 24 and an adder 25, a subtractor 26 allowing to send towards the coding stage the difference between the input signal IS of the coding device and the predicted signal available at the output of the prediction stage (i.e. at the output of the motion compensation circuit 22). This difference, or residual, is the bitstream that is coded. The motion vectors determined by the motion estimation circuit 21 are sent towards a multiplexer 31, together with the output signal of the buffer 15, in order to be multiplexed in the form of an output coded bitstream CB available at the output of said multiplexer 31. Said bitstream CB is the coded bitstream that, according to the invention, will include the additional syntactic element indicating the presence, or not, of differences (dx, dy) that have to be coded.

The invention also relates to a transmittable video signal consisting of a coded bitstream generated by such a video encoding device.

Reciprocally, according to a corresponding decoding method, the additional syntactic element, transmitted to the decoding side within the coded bitstream, is read by appropriate means in a video decoder receiving it and carrying out said decoding method. The decoder, which is able to recognize and decode all the segments of the content of the coded bitstream, reads said additional syntactic element and knows that an encoded residual signal is present or not present. Such a decoder may be of any MPEG-type, as the encoding device, and its essential elements are for instance, in series, an input buffer receiving the coded bitstream, a VLC decoder, an inverse quantizing circuit and an inverse DCT circuit. Both in the coding and decoding device, a controller may be provided for managing the steps of the coding or decoding operations.

The foregoing description of the preferred embodiments of the invention has been presented for purposes of illustration and description. It is not intended to be exhaustive or to limit the invention to the precise forms disclosed, and obviously modifications and variations, apparent to a person skilled in the art and intended to be included within the scope of this invention, are possible in light of the above teachings.

It may for example be understood that the coding and decoding devices described herein can be implemented in hardware, software, or a combination of hardware and software, without excluding that a single item of hardware or software can carry out several functions or that an assembly of items of hardware and software or both carry out a single function. The described methods and devices may be implemented by any type of computer system or other adapted apparatus. A typical combination of hardware and software could be a general-purpose computer system with a computer program that, when loaded and executed, controls the computer system such that it carries out the method described herein. Alternatively, a specific use computer, containing specialized hardware for carrying out one or more of the functional tasks of the invention could be utilized.

The present invention can also be embedded in a computer program product, which comprises all the features enabling the implementation of the method and functions described herein and—when loaded in a computer system—is able to carry out these method and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. A video encoding method applied to a sequence of video frames and generating a coded bitstream in which each data item is described by means of a bitstream syntax allowing any decoder to recognize and decode all the segments of the content of said bitstream, said method including a predicting step, based on a prediction technique using a motion compensation operation between a previous frame and the current one and provided for generating a predicted frame, and a subtracting step, based on a subtraction of said predicted frame from the current one and provided for generating the signal to be encoded, said motion compensation operation itself leading to the generation of motion vectors the horizontal and vertical components (MVx, MVy) of which have to be encoded differentially by using predictions (Px, Py) of said components and encoding only the differences (dx, dy) between said motion vector components and their predictions (Px, Py), said encoding method being further characterized in that said syntax includes an additional flag indicating that said differences (dx, dy) are present, or not, in said generated coded bitstream.

2. A video encoding device for carrying out a video encoding method applied to a sequence of video frames and generating a coded bitstream in which each data item is described by means of a bitstream syntax allowing any decoder to recognize and decode all the segments of the content of said bitstream, said encoding method including a predicting step, based on a prediction technique using a motion compensation operation between a previous frame and the current one and provided for generating a predicted frame, and a subtracting step, based on a subtraction of said predicted frame from the current one and provided for generating the signal to be encoded, said motion compensation operation itself leading to the generation of motion vectors the horizontal and vertical components (MVx, MVy) of which have to be encoded differentially by using predictions (Px, Py) of said components and encoding only the differences (dx, dy) between said motion vector components and their predictions (Px, Py), said encoding device being further characterized in that said syntax includes an additional flag indicating that said differences (dx, dy) are present, or not, in the coded bitstream generated by said encoding device.

3. A transmittable video signal consisting of a coded bitstream generated by a video encoding device for carrying out a video encoding method applied to a sequence of video frames and generating a coded bitstream in which each data item is described by means of a bitstream syntax allowing any decoder to recognize and decode all the segments of the content of said bitstream, said encoding method including a predicting step, based on a prediction technique using a motion compensation operation between a previous frame and the current one and provided for generating a predicted frame, and a subtracting step, based on a subtraction of said predicted frame from the current one and provided for generating the signal to be encoded, said motion compensation operation itself leading to the generation of motion vectors the horizontal and vertical components (MVx, MVy) of which have to be encoded differentially by using predictions (Px, Py) of said components and encoding only the differences (dx, dy) between said motion vector components and their predictions (Px, Py), said transmittable video signal being characterized in that said coded bitstream comprises a syntactic element in the form of an additional flag indicating that said differences (dx, dy) are present, or not, in said coded bitstream.

4. A video decoding method for decoding a transmittable video signal consisting of a coded bitstream generated by implementation of a video encoding method applied to a sequence of video frames and generating a coded bitstream in which each data item is described by means of a bitstream syntax allowing any decoder to recognize and decode all the segments of the content of said bitstream, said encoding method including a predicting step, based on a prediction technique using a motion compensation operation between a previous frame and the current one and provided for generating a predicted frame, and a subtracting step, based on a subtraction of said predicted frame from the current one and provided for generating the signal to be encoded, said motion compensation operation itself leading to the generation of motion vectors the horizontal and vertical components (MVx, MVy) of which have to be encoded differentially by using predictions (Px, Py) of said components and encoding only the differences (dx, dy) between said motion vector components and their predictions (Px, Py), said decoding method being further characterized in that it comprises a step for reading in said coded bitstream an additional flag indicating that said differences (dx, dy) are present, or not, in said coded bitstream and have therefore, or not, to be decoded.

5. A video decoding device for carrying out a video decoding method for decoding a transmittable video signal consisting of a coded bitstream generated by implementation of a video encoding method applied to a sequence of video frames and generating a coded bitstream in which each data item is described by means of a bitstream syntax allowing any decoder to recognize and decode all the segments of the content of said bitstream, said method including a predicting step, based on a prediction technique using a motion compensation operation between a previous frame and the current one and provided for generating a predicted frame, and a subtracting step, based on a subtraction of said predicted frame from the current one and provided for generating the signal to be encoded, said motion compensation operation itself leading to the generation of motion vectors the horizontal and vertical components (MVx, MVy) of which have to be encoded differentially by using predictions (Px, Py) of said components and encoding only the differences (dx, dy) between said motion vector components and their predictions (Px, Py), said decoding device being further characterized in that it comprises means for reading in said coded bitstream an additional flag indicating that said differences (dx, dy) are present, or not, in said coded bitstream and have therefore, or not, to be decoded.
